(19) United States
(12) Patent Application Publication
(10) Pub. No.: US 2012/0066305 A1
(43) Pub. Date: Mar. 15, 2012

(54) TRANSMITTING SYSTEM AND METHOD THEREOF

(75) Inventors: HSU-WEI CHENG, Tu-Cheng (TW); YAN-FENG SI, Shenzhen City (CN)

(73) Assignees: HON HAI PRECISION INDUSTRY CO.,, Tu-Cheng (TW); HONG FU JIN PRECISION INDUSTRY (ShenZhen) CO., LTD., Shenzhen City (CN)

(21) Appl. No.: 13/192,700

(22) Filed: Jul. 28, 2011

(30) Foreign Application Priority Data
Sep. 9, 2010 (CN) 201010277207.5

(51) Int. Cl. G06F 15/16

(52) U.S. Cl. 709/204

(57) ABSTRACT

A datagram transmitting system includes a server and a client. The client includes a first transmitting module and a detecting module. The server includes a management module and a second transmitting module. The detecting module detects whether network congestion and generates a status signal. If network is congested, the detecting module generates a first status signal. The first transmitting module transmits the status signal to the management module. The management module packages a first predetermined length of data into a datagram responding to the first status signal. The first predetermined signal is at most 65,507 bytes but more than 0 bytes in length. The second transmitting module transmits the datagram to the first transmitting module.

### BACKGROUND

1. Technical Field

The present disclosure relates to datagram transmitting systems, particularly, to manipulating data contained in a datagram and method thereof.

2. Description of Related Art

When a user datagram protocol (UDP) is used between a server and a client as a network protocol suite, the server packages a predetermined bytes of data into a datagram. If the server uses the longest length such as 65,507 bytes as the length of the datagram to package the data, when the network gets congested the server will stop sending datagram to the client. Therefore, the data is not transmitted on time and loss of data may result. If the server uses a maximum transmission unit (MTU) such as 1,500 bytes as the length of the datagram to package the data, it will increase the datagram transmitting frequency. Therefore, data will be lost and this may be integrity not stability.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the datagram transmitting system and method thereof. Moreover, in the drawings, like reference numerals designate corresponding parts throughout the several views.

FIG. 1 is a block diagram of a datagram transmitting system in accordance with an embodiment.

FIG. 2 is a flowchart of a transmitting method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage systems. Embodiments of the present disclosure will now be described in detail with reference to the drawings.

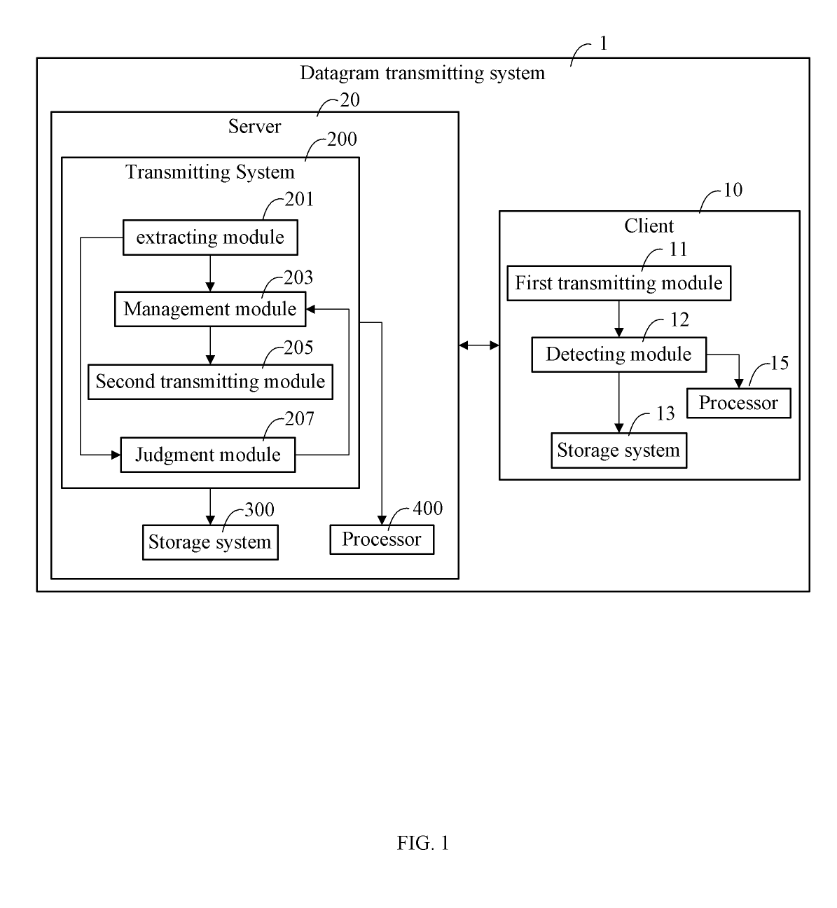

Referring to FIG. 1, a datagram transmitting system 1 comprises a client 10 and a server 20. By using a transmission protocol, the client 10 and the server 20 can connect with each other. The client 10 transmits a request to the server 20 through a network and also receives a datagram from the server 20. The server 20 packages the data as a datagram by a predetermined length and transmits the datagram to the client 10 in response to the request. In the embodiment, the server 20 transmits the datagram based on UDP protocol. The client 10 includes a first transmitting module 11, a detecting module 12, a storage system 13, and a processor 15. The first transmitting module 11 and detecting module 12 may comprise computerized code in the form of one or more programs that are stored in the storage system 13. The computerized code includes instructions that are executed by the at least one processor 15 to provide functions for modules 11 and 12.

The first transmitting module 11 transmits a request to the server 20 and receives the datagram from the server 20.

The detecting module 12 detects whether the client 10 network is congested and generates a status signal to the server 20. If network is congested, the detecting module 12 generates a first status signal. If network is not congested, the detecting module 12 generates a second status signal.

The storage system 13 may be a n on-board memory for the client 10, and also may be an external storage, such as a smart media (SM) card, or secure digital (SD) card, for example.

The processor 15 executes one or more computerized code of the client 10 and applications, to provide the functions of the client 10.

The server 20 includes a transmitting system 200, a storage system 300, and a processor 400. The transmitting system 200 includes an extracting module 201, a management module 203, a second transmitting module 205, and a judgment module 207.

The extracting module 201 extracts the data in response to the request.

The management module 203 packages a length of the extracted data into a datagram responding to the status signal. In the embodiment, when there is no status signal, the management module 203 packages a default length in to a datagram. The management module 203 packages the extracted data in a first predetermined length responding to the first status signal. The management module 203 packages the extracted data in a second predetermined length responding to the second control signal. The first predetermined length and the second predetermined length are at most 65,507 bytes but more than 0 bytes in length. In the embodiment, the default length is 65,507 bytes, the first predetermined length is 1,024 bytes and the second predetermined length is equal to the default length. In other embodiments, the first predetermined length and the second predetermined length can be set at the request of the user.

The second transmitting module 205 transmits the datagram to the client 10 and receives the status signal from the client 10.

The judgment module 207 judges whether there are extracted data in the extracting module 201. If there is no extracted data in the extracting module 201, the judgment module 207 generates a stops signal.

The management module 203 stops packaging of the data into a datagram in response to the stop signal.

In the other embodiment, the detecting module 12 can be set in the server 20 or set apart of the client 10 and the server 20. And additional status of the network can be defined and additional status signals can be generated, such that additional responding predetermined lengths are defined.

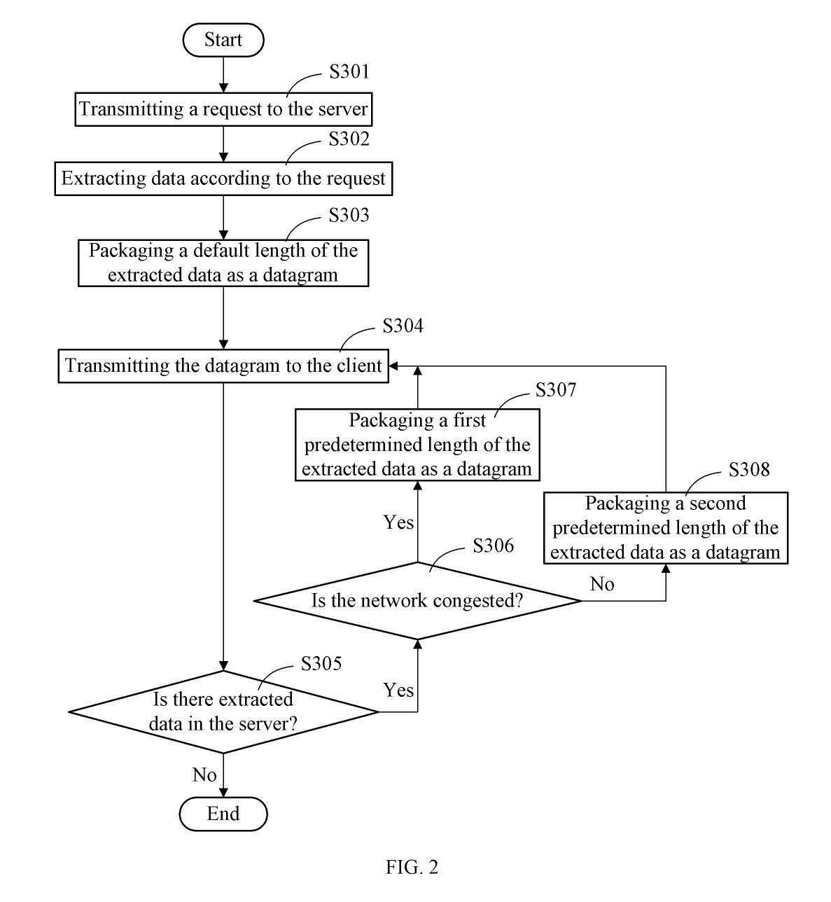

Referring to FIG. 2, a flow chart of a transmitting method for transmitting the datagram between the client 10 and the server 20 in a datagram transmitting system. The transmitting method includes the following steps.

In step S301, the first transmitting module 11 transmits requests to the server when the client 10 and the server 20 connect with each other and step S202 is implemented. In the embodiment, the server 10 and the client connects with each other using the transmission protocol.

In step S302, the extracting module 201 extracts data responding to the request and step S203 is implemented.

In step S303, the management module 203 packages a default length of the extracted data into a datagram and step S204 is implemented. In the embodiment, the default length is 65,507 bytes.

In step S304, the second transmitting module 205 transmits the datagram to the client 20 and step S205 is implemented. In the embodiment, the second transmitting module transmits the datagram based on the UDP protocol.

In step S305, the judgment module 207 judges whether there are extracted data in the server 10. If there are extracted data in the server 10, step S206 is implemented. If there is no extracted data, then the procedure ends.

In step S306, the detecting module 12 detects whether the client 10 network is congested and generates a status signal. If network is congested then the detecting module 12 generates a first status signal and step S307 is implemented. If network is not congested then the detecting module 12 generates a second status signal and step S308 is implemented.

In step S307, the management module 203 packages a first predetermined length of the extracted data into a datagram responding to the first status signal, and step S304 is implemented. In the embodiment, the first predetermined length is 1,024 bytes.

In step S308, management module 203 packages a second predetermined length of the extracted data into a datagram responding to the second control signal, and the step S304 is implemented. In the embodiment, the second predetermined length is equal to the default length, which is 65,507 bytes. In other embodiments, the first predetermined length and the second predetermined length is at most 65,507 bytes in UDP but more than 0 bytes in length and can be set at the request of a user.

As described, by using the datagram transmitting system the bytes contained in a datagram can be adjusted in corresponding to the network status; it optimize the datagram transmitting method.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A datagram transmitting system for transmitting datagram between a server and a client, the datagram transmitting system comprising:
the server comprising at least one processor, a storage system and one or more programs, the one or more programs stored in the storage system, executable by the at least one processor;
the client comprising at least one processor, a storage system and one or more programs, the one or more programs in stored in the storage system, executable by the at least one processor,
the one or more programs comprising:
a detecting module adapted to detect network congestion and generate a status signal, if network is congested the detecting module generates a first status signal;
a first transmitting module adapted to transmit the first status signal;
a management module adapted to package a first predetermined length of data into a datagram responding to the first status signal, the first predetermined length is at most the longest length of a transmitting protocol and more than 0 bytes; and
a second transmitting module adapted to transmit the datagram to the first transmitting module in the server.

2. The datagram transmitting system of claim 1, wherein the first transmitting module and the detecting module are set in the client, the management module and second transmitting module are set in the server.

3. The datagram transmitting system of claim 1, wherein the first predetermined length is 1,024 bytes.

4. The datagram transmitting system of claim 1, wherein if network is congested the detecting module generates a second status signal, the management module packages a second predetermined length of data into a datagram responding to the second status signal.

5. The datagram transmitting system of claim 4, the second predetermined length is 65,507 bytes.

6. The datagram transmitting system of claim 1, wherein when there is no status signal, the management module packages a default length of extracted data as a datagram.

7. The datagram transmitting system of claim 6, wherein the default length is 65,507 bytes.

8. The datagram transmitting system of claim 1, wherein the datagram transmitting system further comprises an extracting module, the first transmitting module also transmits a request to the extracting module, and the extracting module extracts data responding to the request.

9. The datagram transmitting system of claim 1, wherein the datagram transmitting system further comprises a judgment module, the judgment module judges whether there are extracted data in the extracting module, if there is no extracted data in the extracting module, the judgment module stops judging the status signal.

10. The datagram transmitting system of claim 1, wherein the server and the client use the UDP protocol to transmit the datagram.

11. A transmitting method for transmitting datagram between a server and a client, the method comprising:
the server capable of being executed by a processor to perform instructions stored in a storage system;
the client capable of being executed by a processor to perform instructions stored in a storage system;
detecting network congestion and generating a status signal, if network is congested, generating a first status signal;
the server packages a first predetermined length of data into a datagram responding to the first status signal, the first predetermined length is at most the longest length of a transmitting protocol but more than 0 bytes; and
the server transmits the datagram to the client.

12. The method according to claim 11, wherein the first predetermined length is 1,024 bytes.

13. The method according to claim 11, wherein if network is not congested, generating a second status signal; and
the server packages a second predetermined length of data into a datagram, the second predetermined length is at most 65,507 bytes and more than 0 bytes.

14. The method according to claim 13, the second predetermined length is 65,507 bytes.

15. The method according to claim 11, if there is no status signal the server packages a default predetermined length of data into a datagram.

16. The method according to claim 15, wherein the default length is 65,507 bytes.

17. The method according to claim 11, the step detecting network congestion and generating a status signal further comprising:
detecting whether there are extracted data in the server, if there is no extracted data in the server, the procedure ends.

18. The method according to claim 11, the server and the client use the UDP protocol to transmit the datagram.

19. The method according to claim 11, before the step detecting whether network is congested and generating a status signal further comprising:
the client transmits a request to the sever; and
the sever extracts data responding to the request.
